(19) United States
(12) Patent Application Publication
(10) Pub. No.: US 2025/0079700 A1
(43) Pub. Date: Mar. 6, 2025

(54) SYSTEMS AND METHODS FOR ELECTRONICALLY TRANSFORMING SHAPES OF ANTENNA ARRAYS

(71) Applicant: Board of Trustees of UA, for and on behalf of UAH, Huntsville, AL (US)

(72) Inventor: Maria Pour, Huntsville, AL (US)

(73) Assignee: Board of Trustees of UA, for and on behalf of UAH, Huntsville, AL (US)

(21) Appl. No.: 18/667,822

(22) Filed: May 17, 2024

Related U.S. Application Data
(60) Provisional application No. 63/534,997, filed on Aug. 28, 2023.
(60) Provisional application No. 63/535,108, filed on Aug. 29, 2023.
(60) Provisional application No. 63/535,110, filed on Aug. 29, 2023.
(60) Provisional application No. 63/535,113, filed on Aug. 29, 2023.
(60) Provisional application No. 63/535,114, filed on Aug. 29, 2023.
(60) Provisional application No. 63/535,116, filed on Aug. 29, 2023.
(60) Provisional application No. 63/535,119, filed on Aug. 29, 2023.
(60) Provisional application No. 63/535,120, filed on Aug. 29, 2023.
(60) Provisional application No. 63/535,107, filed on Aug. 29, 2023.

(51) Int. Cl. H01Q 3/26; H01Q 3/36

(52) U.S. Cl. CPC H01Q 3/2611; H01Q 3/36

(57) ABSTRACT

An antenna system for electronically transforming shapes of antenna arrays has an array of antennas physically arranged in accordance with a first shape (e.g., circular). When desired, the antennas array is electronically reshaped to effectively transform the array into a different shape (e.g., elliptical) by electronically displacing the phase centers of one or more of the antennas so that the relative coordinates of the phase centers are effectively changed to the new array shape without physically moving the antennas. Thus, for a given situation, the radiation pattern of the antenna array can be effectively and automatically changed to improve performance (e.g., better suppress sidelobes or grating lobes) or perform null steering without physically moving the antennas.

### CROSS REFERENCE TO RELATED APPLICATIONS

This application claims priority to U.S. Provisional Patent Application No. 63/534,997, entitled “Electronic Transformation of a Circular Array to an Elliptical Array: Electronic, geometrical transformation of different regular and irregular contours/lattices in planar and conformal phased array antennas,” and filed on Aug. 28, 2023, which is incorporated herein by reference. This application claims priority to U.S. Provisional Patent Application No. 63/535,107, entitled “Electronic Transformation of a Circular Array to an Elliptical Array: Sidelobe reductions in phased array radars to improve signal-to-noise ratio,” and filed on Aug. 29, 2023, which is incorporated herein by reference. This application claims priority to U.S. Provisional Patent Application No. 63/535,108, entitled “Electronic Transformation of a Circular Array to an Elliptical Array: Electronic null steering, (including single, multiple, sector/wide nulls), for anti-jamming radars to suppress interferences and jammers,” and filed on Aug. 29, 2023, which is incorporated herein by reference. This application claims priority to U.S. Provisional Patent Application No. 63/535,110, entitled “Electronic Transformation of a Circular Array to an Elliptical Array: Electronic beam scanning without having to use phase shifters at the array level or mechanically squeeze a circular array to an elliptical one,” and filed on Aug. 29, 2023, which is incorporated herein by reference. This application claims priority to U.S. Provisional Patent Application No. 63/535,114, entitled “Electronic Transformation of a Circular Array to an Elliptical Array: Simultaneous sidelobe reduction and null steering in concentric ring phased array antennas,” and filed on Aug. 29, 2023, which is incorporated herein by reference. This application claims priority to U.S. Provisional Patent Application No. 63/535,113, entitled “Electronic Transformation of a Circular Array to an Elliptical Array: Electronic beam shaping to reconfigure the antenna field of view over the course of operation,” and filed on Aug. 29, 2023, which is incorporated herein by reference. This application claims priority to U.S. Provisional Patent Application No. 63/535,116, entitled “Electronic Transformation of a Circular Array to an Elliptical Array: Concurrent beam scanning and pattern shaping capabilities in concentric array antennas,” and filed on Aug. 29, 2023, which is incorporated herein by reference. This application claims priority to U.S. Provisional Patent Application No. 63/535,119, entitled “Electronic Transformation of a Circular Array to an Elliptical Array: Radar Applications, including but not limited to, Synthetic Aperture Radar (SAR), Ground Moving Target Indicator (GMTI) Radar, Monopulse Radar with SUM and Difference Patterns, adaptive anti-jamming radars and interference cancellers, multi-functional radars, and massive multi-input multi-output (MIMO) radars,” and filed on Aug. 29, 2023, which is incorporated herein by reference. This application claims priority to U.S. Provisional Patent Application No. 63/535,120, entitled “Electronic Transformation of a Circular Array to an Elliptical Array: Anti-jam Global Positioning System (GPS) array antenna,” and filed on Aug. 29, 2023, which is incorporated herein by reference.

### STATEMENT REGARDING FEDERALLY SPONSORED RESEARCH OR DEVELOPMENT

This invention was made with Government support under contract ECCS-1653915 awarded by the National Science Foundation. The Government has certain rights in the invention.

### RELATED ART

Planar array antennas are often utilized in a variety of systems, including radars and mobile or satellite communication systems. Amongst the numerous planar array configurations, the popularity of circular and elliptical arrays has increased over the past few years due to their inherent ability to generate highly directive patterns with low sidelobe levels (SLLs). Researchers have developed a number of optimization algorithms to determine the ideal excitation coefficients and positions of the antennas along the circular and elliptical contours of these planar arrays to suppress the SLLs and improve their overall performance. Further performance improvement is generally desired.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating an embodiment of an antenna system that is configured to electronically transform a planar array of antennas from one shape to another.

FIG. 2 is a block diagram illustrating an embodiment of a controller for an antenna system, such as is depicted by FIG. 1.

FIG. 3 is a block diagram illustrating a feeding network, such as is depicted by FIG. 1, coupled to a single layer, dual mode patch antenna.

FIG. 4 depicts an antenna array, such as is depicted by FIG. 1, arranged in a circular pattern.

FIG. 5 depicts the antenna array depicted by FIG. 1 after the antenna array has been electronically transformed to an elliptical array.

FIG. 6 is a graph illustrating exemplary radiation patterns for the circular array depicted by FIG. 4 and the elliptical array depicted by FIG. 5.

FIG. 7 is a graph illustrating sidelobe levels (SLLs) versus eccentricity for elliptical arrays transformed from circular arrays of different radii.

FIG. 8 is a graph illustrating peak gain and half power beamwidth (HPBW) versus eccentricity for an elliptical array, such as depicted by FIG. 5.

FIG. 9 is a graph illustrating normalized radiation patterns for a circular array and transformed array for reducing grating lobes with main beam scanned to about 5°.

FIG. 10 is a graph illustrating normalized radiation patterns for a circular array and transformed array for reducing grating lobes with main beam scanned to about 25°.

### DETAILED DESCRIPTION

The present disclosure generally pertains to systems and methods for electronically transforming shapes of antenna arrays. In some embodiments, an antenna system has an array of antennas physically arranged in accordance with a first shape (e.g., circular). When desired, the antenna array is electronically reshaped to effectively transform the array into a different shape (e.g., elliptical) by electronically displacing the phase centers of one or more of the antennas so that the relative coordinates of the phase centers are effectively changed to the new array shape without physically moving the antennas. Thus, for a given situation, the radiation pattern of the antenna array can be effectively and automatically changed to improve performance (e.g., better suppress sidelobes or grating lobes) or perform null steering without physically moving the antennas.

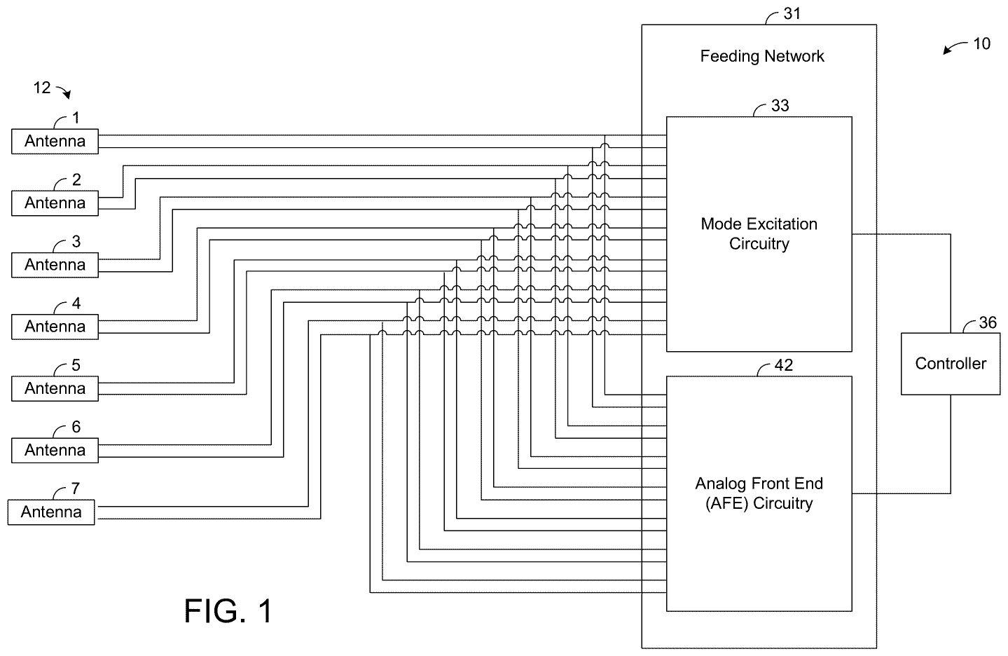

FIG. 1 depicts an embodiment of an antenna system 10 having a planar array 12 of antennas 1-7 for communicating wireless signals. The system 10 is configured to electronically transform the planar array 12 of antennas 1-7 from one shape to another to change the radiation pattern of the planar array 12. As shown by FIG. 1, the system 10 comprises a feeding network 31 that is coupled to each antenna 1-7 of the array 12, and circuitry 33 within the feeding network 31, referred to hereafter as “mode excitation circuitry,” provides at least one control signal to each antenna 1-7 that excites at least one mode of the antenna 1-7 to control the antenna's radiation characteristics, as will be described in more detail below. The mode excitation circuitry 33 is coupled to a controller 36 that is configured to determine the array's optimum radiation characteristics based on various factors and control the mode excitation circuitry 33 to change the array's radiation characteristics by electronically reshaping the array 12.

As an example, when the array 12 is arranged in a circular pattern, the controller 36 may instruct or otherwise cause the mode excitation circuitry 33 to electronically displace the phase center of one or more antennas 1-7 to change the effective shape of the array 12 from circular to elliptical. In other examples, the array 12 can be reshaped in other manners (e.g., changed from elliptical to circular or some other shape).

As shown by FIG. 1, the feeding network 31 may include analog front end (AFE) circuitry 42 that is coupled to the antennas 1-7 and configured to process signals to be transmitted by the antennas 1-7 or received by the antennas 1-7. As an example, for a given signal to be transmitted, the AFE 42 may convert the signal from digital to analog (if a digital signal is received for transmission), as well as amplify and/or shape the analog signal for transmission by a respective antenna 1-7. For a given signal received from a respective antenna 1-7, the AFE 42 may filter the received signal and perform analog-to-digital (A/D) conversion if a digital signal is to be transmitted downstream. In some embodiments, the AFE 42 may be coupled to the controller 36 for receiving from the controller 36 signals to be transmitted by the array 12 or transmitting to the controller 36 signals received from the array 12. In other embodiments, the AFE 42 may be coupled to other downstream components (not shown) instead of the controller 36 for this purpose.

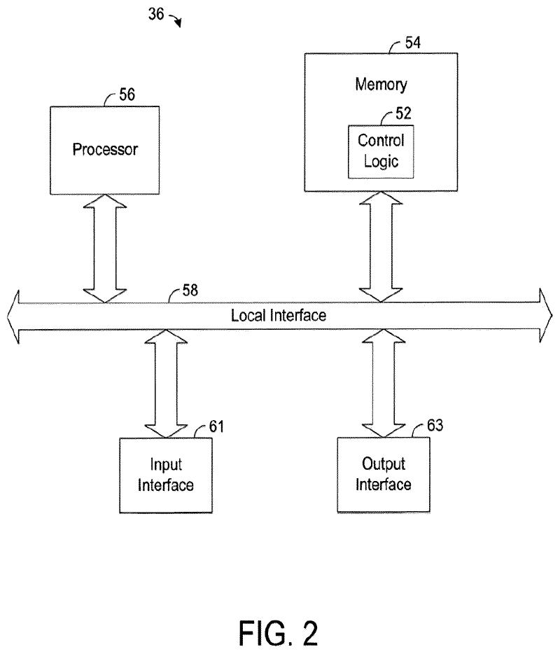

Note that the controller 36 may be implemented in hardware or a combination of hardware with software or firmware. As an example, the controller 36 may be implemented in hardware with a field programmable gate array (FPGA) or other hardware capable of performing the functions ascribed to the controller 36 herein. FIG. 2 depicts an embodiment of the controller 36 when at least a portion of the controller 36 is implemented in software. As shown by FIG. 2, the controller 36 comprises control logic 52 for generally controlling the operation of the controller 36, as will be described in more detail hereafter. In the exemplary controller 36 illustrated by FIG. 2, the control logic 52 is implemented in software and stored in memory 54 of the controller 36.

Note that the control logic 52, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary controller 36 depicted by FIG. 2 comprises at least one conventional processor 56, such as a digital signal processor (DSP) or a central processing unit (CPU), that communicates to and drives the other elements within the controller 36 via a local interface 58, which can include at least one bus. Furthermore, an input interface 61, for example, serial data ports, can be used to receive data or signals from other components of the system 10, and an output interface 63, for example, serial data ports, can be used to output data or signals.

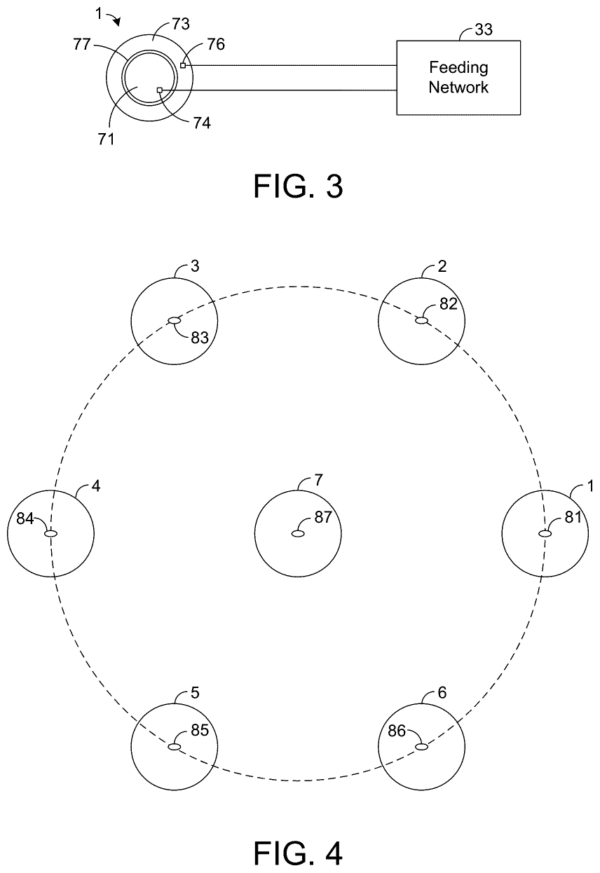

FIG. 3 depicts an embodiment of an antenna 1 coupled to the feeding network 31. The antenna 1 shown by FIG. 3 is a single-layer, dual-mode patch antenna but other types of antennas (including antennas with other numbers of modes) are possible. The antenna 1 has an inner conductive patch 71, generally shaped as a disc, to which a control signal may be applied by the feeding network 31 to excite a first transverse magnetic mode (TM₁₁) for controlling radiation characteristics corresponding to the TM₁₁ mode of the antenna 1. The antenna 1 also has an outer conductive patch 73, forming a ring around the inner patch 71, to which a control signal may be applied by the feeding network 31 to excite a second mode (TM₂₁) for controlling radiation characteristics corresponding to the TM₂₁ mode of the antenna 1. The perimeters of both patches 71 and 73 are circular, but it is possible for the patches 71 and 73 to have other shapes (e.g., rectangular) in other embodiments. As shown by FIG. 3, the inner patch 71 may be electrically coupled to the feeding network 31 via a port 74 on the inner patch 71, and the outer patch 73 may be electrically coupled to the feeding network 31 via a port 76 on the outer patch 73. Further, the antenna patches 71 and 73 may be separated by a ring 77 of electrically insulating material. Note that the other antennas 2-7 may have the same configuration as the antenna 1 shown by FIG. 3 and may be similarly coupled to the feeding network 31.

FIG. 4 depicts an exemplary arrangement of the antennas 1-7 when they are arranged as a circular array (with only a single mode, TM₁₁, excited). Each antenna 1-7 has a respective phase center 81-87 that is located at the antenna's physical center (i.e., the point of intersection of the antenna's diameters in embodiments for which the antenna forms a circle). As known in the art, the phase center refers to the antenna's effective source of radiation, and a single mode may be excited such that the location of the antenna's phase center coincides with the antenna's physical center.

As shown by FIG. 4, assuming that a single mode of the antennas 1-7 is excited, both the physical centers and the phase centers 81-86 of antennas 1-6 are positioned in a circular pattern (i.e., forming a circle referred to hereafter as the “array circle”) around the phase center 87 and physical center of one of the antennas 7, which is located at the center of the array 12 and referred to herein as “central antenna.” That is, the phase center 87 and the physical center of the central antenna 7 are both located at the center of the array circle formed by phase centers 81-86 of the antennas 1-6. For optimal performance, the antennas 1-6 are equally spaced along the array circle with an angular separation of 60°. In one embodiment, the array circle has a radius of 0.8λ₀, where λ₀ is the free space wavelength at a frequency of signals communicated by the antenna (e.g., 10 GHz in one embodiment), although other signal frequencies and array geometries and sizes may be used in other embodiments.

Based on the cavity model, assuming that each array antenna 1-7 is backed by an infinite ground plane separated with by a dielectric with relative permittivity close to εᵣ=1, the total radiation pattern of the x-polarized uniformly excited, seven-element dual-mode, equally spaced circular array depicted by FIG. 4 is calculated by:

$${E}_{θ}^{Total} = {\sum }_{m = 1}^{7} {E}_{θ} ( m ) {e}^{j \{ {k}_{0} [ x ( m ) s i n θ c o s ϕ + y ( m ) s i n θ s i n ϕ ] + β ( m ) \}} \qquad ( 1 )$$

$$where ,$$

$${E}_{θ} ( m ) = - \frac{{je}^{- {jk}_{0} r}}{r} \{ [ {J}_{0} ( {u}_{1} ) - {J}_{2} ( {u}_{1} ) ] cos ϕ + {jA}_{21} ( m ) [ {J}_{1} ( {u}_{2} ) - {J}_{3} ( {u}_{2} ) ] cos 2 ϕ \} \qquad ( 2 )$$

$$x ( m ) = ρcos {ϕ}_{m} \qquad ( 3 )$$

$$y ( m ) = ρsin {ϕ}_{m}$$

$${ϕ}_{m} = \frac{2 π ( m - 1 )}{6} ∀ m = 1 : 6$$

$$and$$

$${u}_{1} = {k}_{0} {a}_{1} sin θ \qquad ( 4 )$$

$${u}_{2} = {k}_{0} {a}_{2} sin θ ,$$

where J is the Bessel function of the first kind with associated eigenvalues of 1.8412 and 3.0542 for the TM₁₁ and TM₂₁ modes, respectively; a₁=0.21λ₀ and a₂=0.38λ₀ are the radii of the circular patches exciting the TM₁₁ and TM₂₁ modes respectively. A₂₁ is the mode content factor, which is a normalized excitation ratio (TM₂₁ to TM₁₁) that determines the magnitude and direction of the phase center displacement. ρ is the radius of the circular, equally-spaced planar array and is 0.8λ₀; ϕₘ is the angular position of the m^{th} element on the circular contour and x(m) and y(m) are the respective x- and y-coordinates. For instance, m=7 represents the central element with x(7)=y(7)=0. The progressive phase shift of the m^{th} element of the array is represented by β.

Knowing the desired distance that an antenna's phase center is to be moved relative to its physical center, the above equations may be used to find the mode content factor, A₂₁, that provides the desired distance. The magnitude and phase of the control signals to be applied to the patches 71 and 73 of the antenna 1-7 can then be calculated or otherwise selected to achieve the calculated value of A₂₁. Applying such control signals to the antenna patches 71 and 73 by the feeding network 31 has the effect of moving the phase center by the desired distance. Thus, using the above equations, it is possible to determine the appropriate control signals (i.e., magnitude and phase of each control signal) to apply to an antenna 1-7 in order to move the antenna's phase center by a desired distance without physically moving such antenna 1-7. That is, for a given antenna 1-6, the magnitude and phase of the control signal applied to the antenna patch 71 and the magnitude and phase of the control signal applied to the antenna patch 73 are controlled such that the excitation ratio (TM₂₁ to TM₁₁) or A₂₁ yields the desired displacement of the phase center according to equations (1) to (4) set forth above.

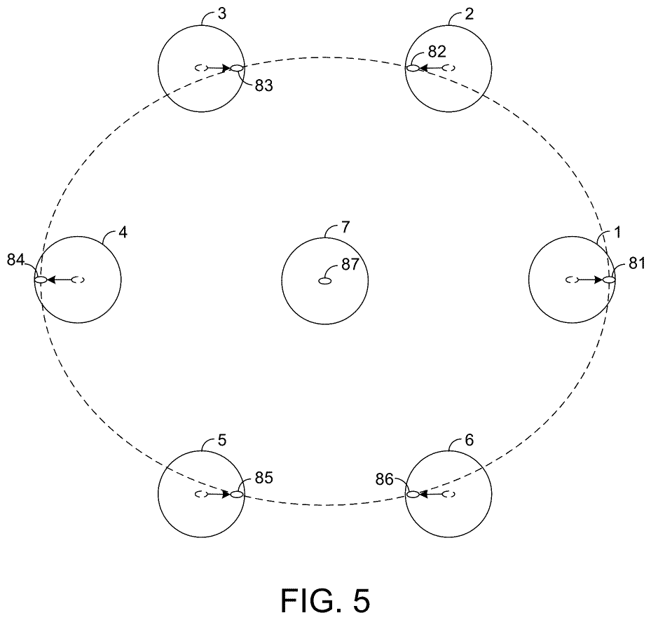

FIG. 5 shows the phase centers 81-87 of the antennas 1-7, respectively, after the phase centers 81-86 have been moved to convert the circular array depicted by FIG. 4 to an elliptical array for which the phase centers 81-86 are arranged in an elliptical pattern (i.e., forming an ellipse referred to hereafter as the “array ellipse”) around the phase center 87 and physical center of the central antenna 7. That is, the phase center 87 and the physical center of the central antenna 7 are both located at the center of the array ellipse formed by the phase centers 81-86 of the antennas 1-6. Note that, in FIG. 5, each phase center 81-86 is associated with a respective reference arrow that shows direction of movement of such phase center for the transformation.

For illustrative purposes, assume that the antennas 1-7 are arranged as a circular array, as shown by FIG. 4, with the physical and phase centers of the antennas 1-6 arranged in a circular pattern around the central antenna 7. Further assume that during operation, the controller 36 based on communication performance or otherwise determines that transformation of the antennas 1-7 from a circular array to an elliptical array is desirable (e.g., to suppress sidelobes). For each antenna 1-6, the controller 36 may be configured to determine the magnitude and phase of each control signal to be applied to the respective antenna by the feeding network 31 such that the antenna's phase center is moved by an amount, as shown by FIG. 5, thereby repositioning the phase centers 81-86 into an elliptical pattern about the central antenna 7. The controller 36 may then instruct or otherwise control the mode excitation circuitry 33 of the feeding network 31 so that the phase centers are so moved. Thus, the array 12 is electronically transformed into an elliptical pattern without physically moving any of the antennas 1-7.

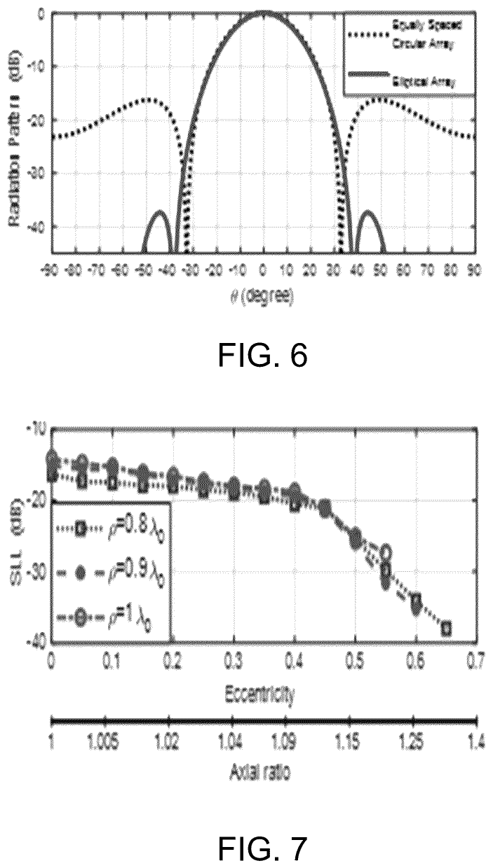

FIG. 6 depicts exemplary radiation patterns induced by the circular array depicted by FIG. 4 and the elliptical array depicted by FIG. 5 assuming the values of phase center displacement in the x-direction (x_{pc}) and A₂₁ indicated by Table 1 with a radius of the circular array equal to 0.8λ₀, where the frequency of the communicated signals is 10 GHz.

TABLE 1

| Elements | 1 | 2 | 3 | 4 | 5 | 6 |
|---|---|---|---|---|---|---|
| x_{pc} (λ₀) | 0.15 | −0.07 | 0.07 | −0.15 | 0.07 | −0.07 |
| A₂₁ | 0.75 | −0.35 | 0.35 | −0.75 | 0.35 | 0.35 |

As shown by FIG. 6, a significant reduction of about 21.7 decibels (dB) for the sidelobes is achieved by transforming the antenna array 12 from a circular pattern to an elliptical pattern.

It is instructive to show how the sidelobe levels (SLLs) vary with the eccentricity of the ellipse formed by the elliptical array shown by FIG. 5. This is plotted in FIG. 7 for different radii of the circle formed by the circular array depicted by FIG. 4. As shown, the SLL gradually drops as eccentricity increases from 0 to about 0.4 and then drastically falls to its minimum value as eccentricity is further increased. Additionally, increasing the radial distance of the circular array from 0.8λ₀ to λ₀ decreases the sidelobe reduction capability of the proposed technique from about 21.7 dB to about 13.2 dB. In particular, it is observed that the lowest SLL is achieved when ρ=0.8\, and eccentricity of the elliptical contour is about 0.65, which is equivalent to an axial ratio of about 1.3.

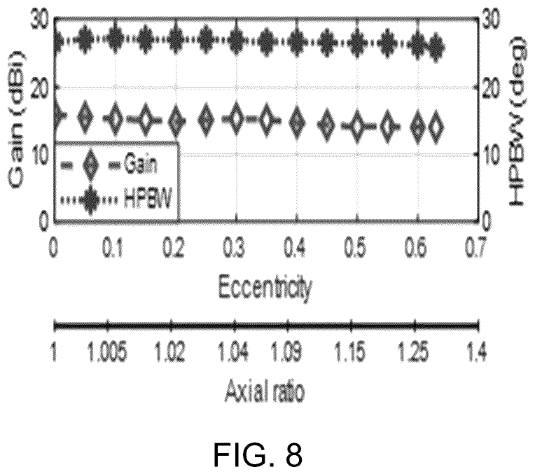

The peak gain and half power beamwidth (HPBW) of the elliptical array depicted by FIG. 5 with ρ=0.8λ₀ are plotted in FIG. 8 for different eccentricity values from 0 to 0.65. As shown, the overall gain and HPBW values of the planar array are relatively constant.

As shown above, the techniques for electronically transforming antenna arrays 12 from circular patterns to elliptical patterns can result in a significant reduction of SLLs without having to physically move any of the antennas 1-7 of the array 12. In other embodiments, one or more phase centers may be electronically displaced for other reasons.

As an example, in some embodiments, phase centers may be electronically moved in order to reduce grating lobes. In this regard, for some designs of antenna arrays 12 (e.g., large array structures), the spacing between antennas may be increased in an effort to reduce costs by reducing the total number of antennas used in the array 12. However, once the spacing is increased beyond about half of a wavelength, undesirable grating lobes begin to appear in the visible region of the radiation pattern. In some embodiments, the phase centers of the antennas are electronically displaced in order to break the array's periodicity, thus facilitating the reduction of grating lobes.

The proposed array for reducing grating lobes may comprise circular microstrip patch antenna designed to excite both the TM₁₁ and TM₂₁ modes, as described above and shown by FIGS. 4 and 5. If the two modes are kept exactly in or out of phase, the phase center can be displaced from the center of the circular patch a distance along the x-axis proportional to the magnitude of the mode content factor. A few representative examples of the relationship between the distance by which the phase center is displaced and the excitation magnitude are shown in Table II below.

TABLE II

| | | Phase Center |
|---|---|---|
| | α₂₁ | Displacement |
| \|A₂₁\| | (degrees) | (λ₀) |
| 0 | — | 0 |
| 0.5 | 0 | 0.11 |
| | 180 | −0.11 |
| 1 | 0 | 0.22 |
| | 180 | −0.22 |

Prior to transformation by moving the phase centers, as described above, the antennas may be arranged as a circular array, as shown by FIG. 4, with element spacing (d) from one antenna to the next equal to λ₀, although other patterns and antenna spacings may be used in other embodiments. The center antenna 7 acts as a partially radiation-matched element with a₂₁=∠±90°, while the outer antennas 1-6 to the left and right of center are excited with 0° and 180° phase shifts, respectively. This allows the phase centers 81-86 of the antennas 1-6 along the outer ring to be displaced in order to break the array's periodicity thereby reducing the grating lobes. The use of the center antenna 7 as a partially radiation-matched antenna does introduce asymmetry into the radiation patterns, which is significantly advantageous when the main beam is scanned away from the boresight direction of θ=0°.

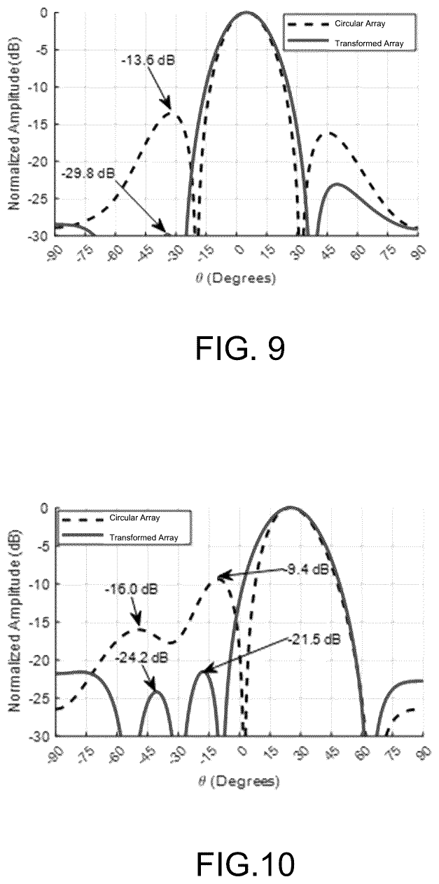

While this method is capable of reducing the grating lobes, one drawback is an increase in the half-power beamwidth (HPBW) of the radiation pattern. In order to balance the tradeoff between grating lobe reduction and beam broadening, an optimization technique based on a Genetic Algorithm (GA) may be used to determine the excitation magnitudes. Using the values produced by the GA, a reduction in the grating lobe level by as much as about 16 dB for lower scan angles has been achieved, as shown by FIG. 9. However, this number drops to about 8 dB by the time the beam is scanned to about 25°, as shown by FIG. 10. As the scan angle is increased, a larger amount of beam broadening factor must be accepted in order to achieve increased reductions in the grating lobes. In the first case, the HPBW is increased by about 8.43%, while the second case sees an increase of about 15.58%.

In some embodiments, the techniques described herein may be used for electronic null steering (including single, multiple, sector/wide nulls) to suppress interferences and jammers. As an example, assume that the system 10 is in communication with a remote device, referred to hereafter as “target,” that is a certain direction from the planar array 12. Also, assume that an interferer located at a different direction from the planar array 12 is attempting to jam communications with the target by emitting a jamming signal at the same frequency as the signals communicated with the target.

The controller 36 may be configured to analyze the signals received by the planar array 12 through the AFE 42 to estimate a direction from which interference is being received. Note that there are various known techniques that may be used by the controller 36 for estimating a direction of an interferer, such as a Multiple Signal Classification (MUSIC) spectrum-based method. Knowing the direction from which the interferer is located, the controller 36 may be configured to use the techniques described herein to electronically adjust the phase centers 81-86 of antennas 1-6 such that a null is steered to the direction of the interferer. As an example, if the target is located at 20° from the array 12 and the interferer is located at 50° from the array 12, then the locations of the phase centers 81-86 may be adjusted such that the radiation pattern of the array 12 is adjusted to steer a null of the radiation pattern to 50°. Specifically, the radiation pattern may be adjusted such that a null of the radiation pattern is moved to coincide with the direction of the interferer (e.g., 50° from the array 12 in this example), thereby suppressing the jamming signal emitted by the interferer.

Note that the systems 10 described above may be used in various applications, including communication systems for transmitting and/or receiving wireless signals from remote devices or systems and radar applications. As described above, the system 10 may be used to suppress sidelobes and grating lobes, as well as to perform electronic null steering to suppress interference. The null steering techniques may be used herein to suppress interference (e.g., jamming) in many different types of systems, including radar and military applications and global positioning system (GPS) receivers. In some embodiments, the effective shape of the array 12 may be changed for a combination of purposes, such as simultaneous sidelobe or grating lobe reduction with null steering to reduce interference. Further, the techniques described herein for displacing the phase centers of antennas may be used without hindering other conventional techniques for adjusting radiation patterns based on manipulation of signal amplitude and phase, such as beam shaping and beam scanning.

Now, therefore, the following is claimed:

1. An antenna system, comprising:
a plurality of planar antennas arranged in a circular pattern;
a feeding network coupled to each of the plurality of planar antennas, wherein for each respective planar antenna of the plurality of planar antennas, the feeding network is configured to apply, to the respective planar antenna, a first control signal for controlling a first transverse magnetic (TM) mode and a second control signal for controlling a second TM mode; and
a controller configured to control the feeding network such that the feeding network adjusts the first control signal or the second control signal applied to at least one planar antenna of the plurality of planar antennas for moving a phase center of the at least one planar antenna to electronically transform the plurality of planar antennas to an elliptical array.

1. The system of claim 1, wherein the feeding network is configured to adjust the first control signal or the second control signal applied to the at least one planar antenna such that sidelobes in radiation patterns for the plurality of planar antennas are reduced.

2. The system of claim 1, wherein the feeding network is configured to adjust the first control signal or the second control signal applied to the at least one planar antenna such that grating lobes in radiation patterns for the plurality of planar antennas are reduced.

3. The system of claim 1, wherein the controller is further configured to determine a direction of an interferer relative to the plurality of planar antennas and adjust the first control signal or the second control signal applied to the at least one planar antenna based on the determined direction such that a null of a radiation pattern for the plurality of planar antennas is steered to the determined direction, thereby suppressing interference from the interferer.

4. A method, comprising:
communicating signals with a plurality of planar antennas arranged in a circular pattern;
applying a plurality of control signals to each of the plurality of planar signals, wherein for each respective planar antenna of the plurality of planar antennas, the plurality of control signals includes, for each respective planar antenna of the plurality of planar antennas, a first control signal for controlling a first transverse magnetic (TM) mode and a second control signal for controlling a second TM mode; and
adjusting the control signals for moving a phase center of at least one planar antenna of the plurality of planar antennas to electronically transform the plurality of planar antennas to an elliptical array.

5. The method of claim 5, wherein the adjusting is performed such that sidelobes in radiation patterns for the plurality of planar antennas are reduced.

6. The method of claim 5, wherein the adjusting is performed such that grating lobes in radiation patterns for the plurality of planar antennas are reduced.

7. The method of claim 5, further comprising:
determining a direction of an interferer relative to the plurality of planar antennas; and
steering a null of a radiation pattern for the plurality of planar antennas to the determined direction, thereby suppressing interference from the interferer, wherein the steering comprises adjusting the control signal based on the determined direction.
